(19) United States
(12) Patent Application Publication
(10) Pub. No.: US 2025/0272616 A1
(43) Pub. Date: Aug. 28, 2025

(54) METHOD AND SYSTEM FOR GENERATING CODE FOR A USER INTERFACE (UI)

(71) Applicant: HCL Technologies Limited, New Delhi (IN)

(72) Inventors: Simy Chacko, Chennai (IN); Ramesh Gurusamy, Chennai (IN); Venkatesh Shankar, Chennai (IN)

(21) Appl. No.: 19/063,417

(22) Filed: Feb. 26, 2025

(30) Foreign Application Priority Data
Feb. 27, 2024 (IN) 202411014447

(51) Int. Cl. G06N 20/00

(52) U.S. Cl. CPC G06N 20/00

(57) ABSTRACT

The disclosure relates to a method and system of generating training data for fine-tuning of a Machine Learning (ML) model. The method includes generating one or more natural language interpretations of a dataset corresponding to one or more parameters associated with configuration of the dataset, and collating the one or more natural language interpretations of the dataset corresponding to one or more parameters, to generate a combined natural language interpretation of the dataset. The method further include generating a conceptual explanation of the dataset, based on the combined natural language interpretation of the dataset, and assigning one or more labels to each sub-dataset of the dataset, based on the conceptual explanation of the dataset, to generate training data for fine-tuning of the ML model, wherein the dataset comprises a plurality of sub-datasets.

### TECHNICAL FIELD

This disclosure relates generally to code generation, and in particular to a method and a system for generating code for a User Interface (UI) using Generative artificial intelligence (GenAI) technology.

### BACKGROUND

A Large language model (LLM) is a type of artificial intelligence (AI) model that is trained on vast amounts of text data and is able to generate human-like language. LLMs are typically trained using deep learning techniques such as neural networks. In order to guide the LLMs to generate the text, LLMs are provided with (text) prompts as input. A prompt is a text that is used to provide context and direction to the LLM. Prompts can take many different forms depending on the task. For example, a prompt may be a question, a statement, a keyword, or a phrase. In some cases, prompts may also include additional information such as a desired output format, length, or style. As such, prompts must be chosen carefully to ensure that they are appropriate for the task. A well-designed prompt can help to guide the LLM towards generating high-quality output.

With using LLMs, it is important to handle sensitive or confidential data in a secure and responsible manner. Sensitive data may include personal information such as social security numbers, financial information such as credit card numbers, medical records, and other types of data that could potentially cause harm if it falls into the wrong hands. To ensure that sensitive data is handled appropriately, various strong measures are required. Conventionally, these measures include implementing secure data storage systems, using strong encryption methods to protect data in transit, limiting access to sensitive data to authorized personnel only, and implementing strict security protocols to prevent unauthorized access. However, implementing these measures can prove challenging. Further, organizations may also need to provide training and education to employees on best practices for handling sensitive data, in terms of providing guidelines on identifying sensitive data, securely storing and transmitting data, and responding in the event of a security breach or data leakage.

Therefore, there is a need for effective and efficient solutions for generating code for a User Interface (UI) using Generative artificial intelligence (GenAI) technology.

### SUMMARY

In an embodiment, a method of generating code for a User interface (UI) is disclosed. The method may include receiving, from a user, a graphical selection of a target portion of a prototype user interface (UI) rendered via a viewer, using a snipping function. The target portion of the prototype UI may include a plurality of components. The method may further include extracting a text representation associated with each of the plurality of components within the target portion of the prototype UI, and mapping a text representation associated with each of one or more non-Personally Identifiable Information (PII) components of the plurality of components to one or more text-based prompt-templates. The one or more text-based prompt-templates may be prestored in a database. The method may further include generating one or more prompts for feeding to a Large Language Model (LLM) for generating a code for the UI, based on the mapping.

In another embodiment, a system for generating code for a User interface (UI) is disclosed. The system includes a processor and a memory communicatively coupled to the processor. The memory stores a plurality of processor-executable instructions. The processor-executable instructions, upon execution by the processor, cause the processor to receive a graphical selection of a target portion of a prototype user interface (UI) rendered via a viewer, using a snipping function. The target portion of the prototype UI may include a plurality of components. The processor-executable instructions may further cause the processor to extract a text representation associated with each of the plurality of components within the target portion of the prototype UI, and map a text representation associated with each of one or more non-Personally Identifiable Information (PII) components of the plurality of components to one or more text-based prompt-templates. The one or more text-based prompt-templates may be prestored in a database. The processor-executable instructions may further cause the processor to generate one or more prompts for feeding to a Large Language Model (LLM) for generating a code for the UI, based on the mapping.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating code for a User interface (UI), in accordance with some embodiments of the present disclosure.

FIG. 2 is a functional block diagram of a code generating device showing one or more modules, in accordance with some embodiments.

FIG. 3 is a process flow diagram of a process of generating code for a UI, in accordance with some embodiments.

FIG. 4 is a flowchart of a method of code for a UI, in accordance with some embodiments.

FIG. 5 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The present subject matter describes a method and system for generating code for a User Interface (UI), using a UI prototype. As will be appreciated by those skilled in the art, UI prototyping is a process of creating a preliminary version of a UI design that can be tested and evaluated before the design is finalized. UI prototyping allows designers to quickly visualize the layout, functionality, and overall user experience of a product. UI prototyping further offers various advantages including helping in visualizing the design, and saving time and resources by helping in identifying the issues and gaps at earlier stages. As such, UI prototyping helps to ensure that the final product is user-friendly, intuitive, and meets the needs of its intended audience.

In some embodiments, the techniques of the present subject matter include establishing a UI prototype viewer or a plugin within standard browsers, to allow a user to select a portion of the UI prototype. Components (e.g. HTML content) within the portion are extracted. Further, images, buttons (actions), and the navigation options (e.g., menu to a page, breadcrumbs, etc.) on the page of the UI prototype are extracted. The viewer/plugin has the capability to handle the UI prototypes which are in image format. Further, the system retrieves the HTML text details from the selected portion and identifies all HTML components including images. If the component is in image format, then plugin/viewer may convert it into respective HTML components. Further, the techniques perform the classification for the HTML, and classify the components as PII and non-PII data.

A classification module then classifies the components as Personally Identifiable Information (PII) components and non-PII components. As such, by performing PII data classification, the techniques provide for falsification of the sensitive information. Further, the techniques enforce audit logging and access control as part of the generated code, and enforce all the basic input validation and boundary conditions for the API operations.

Prompts are generated based on the non-PII data, that are later used for generating code using a large language model (LLM), also known as generative AI (GenAI) model. Additionally, context information (for example, header, breadcrumb, menu options, etc.) is extracted for the components. Further, based on the action button sequence, the components are mapped to different prompt-templates for the code generation. The prompt-templates may be updated and fed to the LLM for code generation. The prompt-templates are pre-designed UI elements that can be used as a starting point for creating a UI. Prompt-templates may include various features including buttons, menus, forms, and other common UI components.

Based on code generation, the techniques further provide the user an option for schema generation, schema updation (of the existing schema), service generation (REST Endpoints), client code generation (standard clients like cURL, Postman, etc.), and client data validation code generation. Further, the techniques provide options for performing falsification and defalsification from the client, and ensuring data access control on all the generated code. The final output code may, therefore, include data schema design, services associated with the data schema, including: ‘add’, ‘delete’, ‘update’, and ‘listing/search’ options. The final output code may further include services associated with other common/repeated functionality, including: ‘login/logout’, ‘profiles/settings’, ‘image/file upload’, ‘report generation’, ‘dashboards’, ‘notifications’, ‘backend REST’ services, and code for data validation. As such, the output code describes a software system and its components. Furthermore, the output code specifies the code for data validation, which ensures that the data entered into the system meets certain criteria or standards.

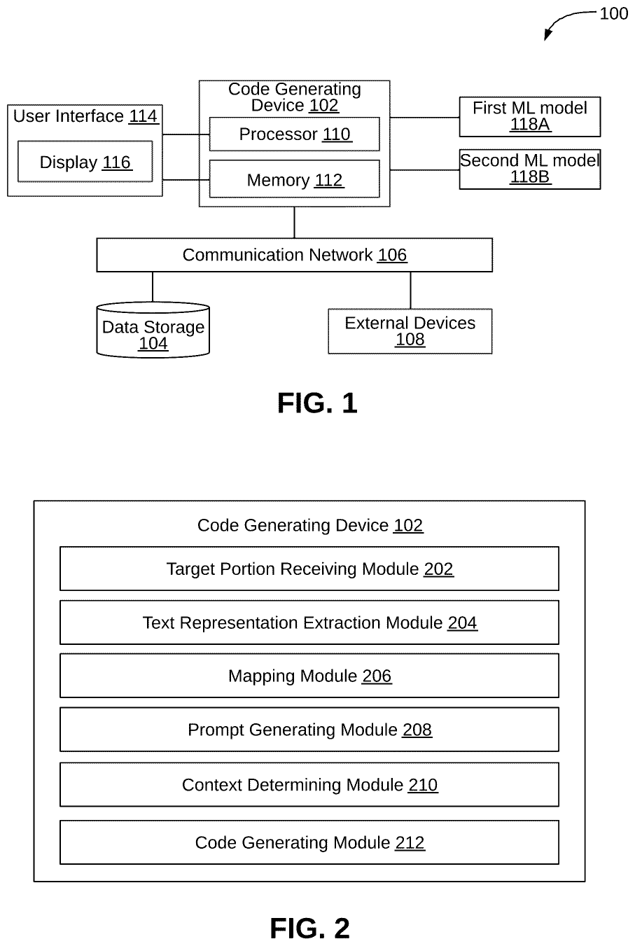

Referring now to FIG. 1, a block diagram of an exemplary system 100 for generating code for a User interface (UI) is illustrated, in accordance with some embodiments of the present disclosure. The system 100 may implement a code generating device 102. Further, the system 100 may include a data storage 104. In some embodiments, the data storage 104 may store at least some of the data related to the UI and the associated code. The code generating device 102 may be a computing device having data processing capability. In particular, the code generating device 102 may have the capability for generating code for a UI. Examples of the code generating device 102 may include, but are not limited to a desktop, a laptop, a notebook, a netbook, a tablet, a smartphone, a mobile phone, an application server, a web server, or the like.

Additionally, the code generating device 102 may be communicatively coupled to an external device 108 for sending and receiving various data. Examples of the external device 108 may include, but are not limited to, a remote server, digital devices, and a computer system. The code generating device 102 may connect to the external device 108 over a communication network 106. The code generating device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108. For example, the communication network 106 may be a wireless network, a wired network, a cellular network, a Code Division Multiple Access (CDMA) network, a Global System for Mobile Communication (GSM) network, a Long-Term Evolution (LTE) network, a Universal Mobile Telecommunications System (UMTS) network, a Worldwide Interoperability for Microwave Access (WiMAX) network, a Dedicated Short-Range Communications (DSRC) network, a local area network, a wide area network, the Internet, satellite or any other appropriate network required for communication between the code generating device 102 and the data storage 104 and the external device 108.

The code generating device 102 may be configured to perform one or more functionalities that may include receiving, from a user, a graphical selection of a target portion of a prototype user interface (UI) rendered via a viewer, using a snipping function. The target portion of the prototype UI may include a plurality of components. The one or more functionalities may further include extracting a text representation associated with each of the plurality of components within the target portion of the prototype UI, and mapping a text representation associated with each of one or more non-Personally Identifiable Information (PII) components of the plurality of components to one or more text-based prompt-templates. The one or more text-based prompt-templates may be pre-stored in a database (e.g. the database 104). The one or more functionalities may further include generating one or more prompts for feeding to a Large Language Model (LLM) for generating a code for the UI, based on the mapping.

It should be noted that the prompt-template may include prompts which may be used as templates with placeholders to populate parameters. Using the parameters, the prompt-template may generate an actual prompt that can be used with the LLM for generating code for the UI. For example, in a mock screen of a ‘Login’ operation (i.e. prototype UI), the code generating device 102 may capture a target portion of the prototype UI to extract a text representation associated with the plurality of components within the target portion. Further, code generating device 102 may select an applicable prompt-template, according to button actions (i.e. actions related to the login operation). The code generating device 102 may further fill up the prompt-template with the extracted text representation (associated with the plurality of components) and generate the final prompt that can be used for the generating code related to the login flow (UI).

To perform the above functionalities, the code generating device 102 may include a processor 110 and a memory 112. The memory 112 may be communicatively coupled to the processor 110. The memory 112 stores a plurality of instructions, which upon execution by the processor 110, cause the processor 110 to perform the above functionalities. The system 100 may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the code generating device 102.

In some embodiments, the system 100 may further implement a first Machine Learning (ML) model 118A and a second ML model 118B. As will be explained in detail in the subsequent sections of the present disclosure, the first ML model 118A may be used for classifying plurality of components as one of: a PII component and a non-PII component. The second ML model 118B may be used for determining a context associated with a target portion of the prototype UI, based on the plurality of components.

Referring now to FIG. 2, a block diagram of the code generating device 102 showing one or more modules is illustrated, in accordance with some embodiments. In some embodiments, the code generating device 102 may include a target portion receiving module 202, a text representation extraction module 204, a mapping module 206, a prompt generating module 208, a context determining module 21, and a code generating module 212.

The target portion receiving module 202 may be configured to receive a graphical selection of a target portion of a prototype user interface (UI) rendered via a viewer, from a user. In some embodiments, the target portion receiving module 202 may receive the graphical selection of the target portion of the prototype UI via a snipping function. By way of an example, the code generating device 102 may implement a browser or a UI viewer for rendering the prototype UI. The browser or the UI viewer may further implement the snipping function. The snipping function may allow the user to select the portion of the prototype UI, for example, by way of a custom rectangular selection box. The target portion of the prototype UI may include a plurality of components associated with the UI.

The text representation extraction module 204 may be configured to extract a text representation associated with each of the plurality of components within the target portion of the prototype UI. It should be noted that each of the plurality of components may be one of: a text-type component or an image-type component. For example, the text-type component may include characters embedded in the prototype UI in the text format. The image-type component may include images (for example, logo, navigation elements, etc.) which may represent some text information. To this end, the text representation extraction module 204 may be further configured to convert the image-type component into a corresponding text-type component, using an Optical Character Recognition (OCR) model.

It should be noted further noted that each of the plurality of components may be one of a Personally Identifiable Information (PII) component and a non-PII component. The PII component may be associated with sensitive data that may include personal information such as social security numbers, financial information such as credit card numbers, medical records, etc. As will be understood, the sensitive data could potentially cause harm if it falls into wrong hands. The mapping module 206 may be configured to classify each of the plurality of components as one of: the PII component and the non-PII component, based on a trained first Machine Learning (ML) model 118A. In other words, the mapping module 206 may implement or work in tandem with the first ML model 118A to classify each of the plurality of components as either a PII component or a non-PII component.

In order for the first ML model 118A to classify the plurality of components as PII components and non-PII component, first, the first ML model 118A may be trained on a diverse dataset containing examples of both PII and non-PII data. The dataset may be annotated with appropriate labels for supervised learning. Further, the relevant features may be identified from the data that the first ML model 118A can use for classification. For example, the relevant features may include text patterns, data structures, or contextual information. Furthermore, the dataset may be split into training and validation sets, and the first ML model 118A may be trained on the training set, adjusting parameters to optimize performance. The performance of the first ML model 118A may be evaluated using metrics like accuracy, precision, recall, and F1 score, and the first ML model 118A may be fine-tuned based on evaluation results to improve its accuracy and reduce false positives/negatives. By using the first ML model 118A for the classification, data security and compliance with privacy regulations is enhanced.

The prompt generating module 208 may be configured to generate one or more prompts for feeding to a Large Language Model (LLM). The LLM may generate a code for the UI, based on the mapping, corresponding to the one or more prompts. As mentioned above, the prompt-template may include prompts which may be used as templates with placeholders to populate parameters. Using the parameters, the prompt-template may generate an actual prompt that can be used with the LLM for generating code for the UI.

For example, in a mock screen of a ‘Login’ operation (i.e. prototype UI), the target portion receiving module 202 may capture a target portion of the prototype UI. Thereafter, the text representation extraction module 204 may extract a text representation associated with the plurality of components within the target portion. The mapping module 206 may map the text representation associated with each of one or more non-Personally Identifiable Information (PII) components of the plurality of components to one or more text-based prompt-templates. The prompt generating module 208 may select an applicable prompt-template, according to button actions (i.e. actions related to the login operation). The prompt generating module 208 may further fill up the prompt-template with the extracted text representation (associated with the plurality of components) and generate the final prompt that can be used for the generating code related to the login flow (UI).

The context determining module 210 may be configured to determine a context associated with the target portion of the prototype UI, based on the plurality of components, using a trained second ML model 118B. The code generating module 212 may be configured to feed the one or more prompts, and the context associated with the target portion of the prototype UI to the LLM model. The code generating module 212 may be further configured to receive the code for the UI from the LLM model. The LLM may be configured to generate the code for the UI based on the one or more prompts, and the context associated with the target portion of the prototype UI. For example, the (generated) code may include a data schema, one or more services associated with the data schema, one or more services associated with UI functionality, one or more backend Representational State Transfer (REST) services, and validation data. In some embodiments, the one or more services associated with the data schema may include: an ‘add’ feature, a ‘delete’ feature, an ‘update’ feature, and a ‘listing’ feature. Further, the one or more services associated with UI functionality may include a ‘login/logout’ feature, a ‘profiles’ feature, an ‘upload’ feature, a ‘report generation’ feature, a ‘dashboard’ feature, and a ‘notifications’ feature.

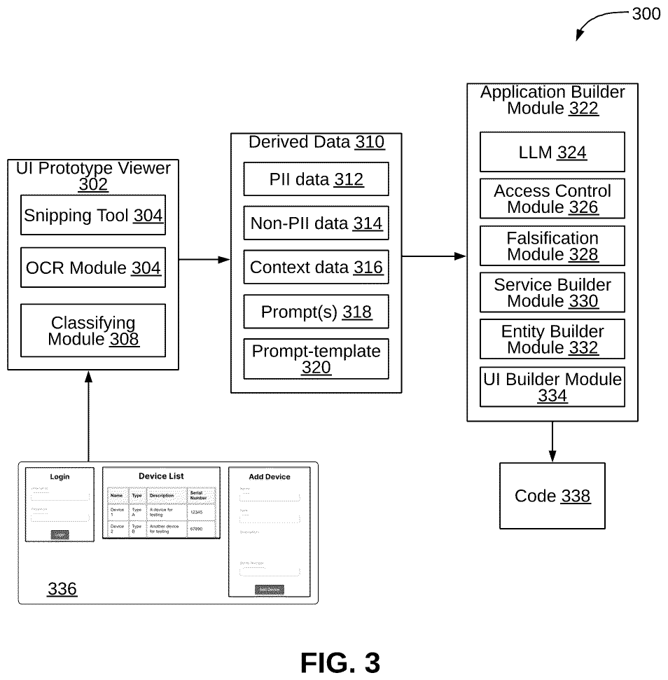

Referring now to FIG. 3, a process flow diagram 300 of a process of generating code for a UI is illustrated, in accordance with some embodiments.

In some embodiments, the prototype UI may be rendered via a UI prototype viewer 302. The UI prototype viewer 302, for example, may be a browser or a dedicated prototype viewer implemented by the code generating device 102. The UI prototype viewer 302 may further implement a snipping function snipping tool 304 that may be configured to allow the user to select the portion of a prototype UI 336, for example, by way of a custom rectangular selection box. By way of an example, the prototype UI 336 may include ‘Login’ operation page, a ‘Device list’ page, or an ‘add device’ operation page. The target portion of the prototype UI may include a plurality of components associated with the UI. In some embodiments, the UI prototype viewer 302 may further implement an Optical Character Recognition (OCR) module 306. As mentioned above, each of the plurality of components may be one of: a text-type component and an image-type component. The OCR module 306 may be used to convert the image-type component into a corresponding text-type component. The text extracted from the text-type component and the image-type component may be then sent to an application builder module (322).

Each of the plurality of components is one of a PII component and a non-PII component. The classifying module 308 may be configured to classify each of the plurality of components as one of: the PII component and the non-PII component, based on the trained first ML model (e.g. first ML model 118A). In particular, the classifying module 308 may be configured to map the text representation associated with each of one or more non-PII components to one or more text-based prompt-templates 320. As such, the one or more text-based prompt-templates 320 may be obtained as part of the derived data 310.

As a result of the processing by the above modules implemented by the UI prototype viewer 302, derived data 310 may be obtained. The derived data may include PII data (i.e. PII components) 312 and non-PII data (i.e. non-PII components) 314, obtained in response to the classification performed by the classifying module 308. Further, context data 316 may be generated by context determining module 210, based on the plurality of components, using the trained second ML model 118B. Furthermore, one or more prompts 318 may be generated by the prompt generating module 208, based on the mapping based on the one or more text-based prompt-templates 320.

Once the prompts 318 are generated, the prompts 318 may be fed to an application builder module 322. The application builder module 322 may further implement a LLM 324, an access control module 326, a falsification module 328, a service builder module 330, an entity builder module 332, and a UI builder module 334. The one or more prompts may be fed to the LLM 324 that may generate the code for the UI based on the one or more prompts and the context associated with the target portion of the prototype UI. The access control module 326 may limit access to sensitive data. To this end, once the plurality of components are classified as one of: the PII component and the non-PII component (based on the trained first ML model 118A), the falsification module 328 may remove the PII components. As such, only the non-PII components may be used for code generation.

For example, the (generated) code may include a data schema, one or more services associated with the data schema, one or more services associated with UI functionality, one or more backend Representational State Transfer (REST) services, and validation data. To this end, the service builder module 330 may be configured to generate the one or more services associated with the data schema and the one or more services associated with UI functionality. In some embodiments, the one or more services associated with the data schema may include: an ‘add’ feature, a ‘delete’ feature, an ‘update’ feature, and a ‘listing’ feature. Further, the one or more services associated with UI functionality may include a ‘login/logout’ feature, a ‘profiles’ feature, an ‘upload’ feature, a ‘report generation’ feature, a ‘dashboard’ feature, and a ‘notifications’ feature. The entity builder module 332 may generate the prompts for database interactions like entities, repositories within the context. The UI builder module 334 may be configured to generate (front-end) code 338 corresponding to the one or more prompts. Further, in some embodiments, the outputted code 338 may include output of the generated code and respective folder structure of entity and repository details, REST endpoints, UI with JavaScript, etc.

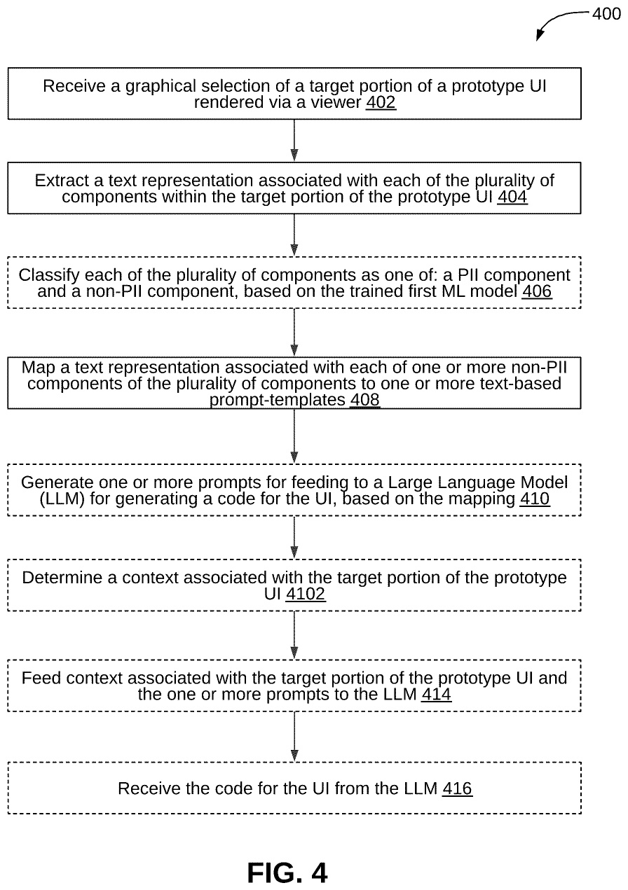

Referring now to FIG. 4, a flowchart of a method 400 of generating code for a User interface (UI) is illustrated, in accordance with some embodiments. For example, the method 400 may be performed by the code generating device 102, or in particular, the processor 110.

At step 402, a graphical selection of a target portion of a prototype UI rendered via a viewer may be received from a user. The graphical selection may be received, for example, using a snipping function. The target portion of the prototype UI may include a plurality of components. At step 404, a text representation associated with each of the plurality of components within the target portion of the prototype UI may be extracted. Each of the plurality of components may be one of: a text-type component and an image-type component. As such, extracting the text representation may further include step 406A at which the image-type component may be converted into a corresponding text-type component, using an Optical Character Recognition (OCR) model.

In some embodiments, upon extracting the text representation associated with each of the plurality of components within the target portion of the prototype UI, at step 406, each of the plurality of components may be classified as one of: a PII component and a non-PII component, based on the trained first ML model 118A. At step 408, a text representation associated with each of one or more non-PII components of the plurality of components may be mapped to one or more text-based prompt-templates. The one or more text-based prompt-templates may be pre-stored in a database. At step 410, one or more prompts may be generated for feeding to a Large Language Model (LLM) for generating a code for the UI, based on the mapping.

Additionally, in some embodiments, at step 412, a context associated with the target portion of the prototype UI may be determined, based on the plurality of components, using the trained second ML model 118B. At step 414, the context associated with the target portion of the prototype UI and the one or more prompts may be fed to the LLM. At step 416, the code for the UI may be received from the LLM. To this end, the LLM may be configured to generate the code for the UI based on the one or more prompts, and the context associated with the target portion of the prototype UI. In some embodiments, the generated code may include a data schema, one or more services associated with the data schema, one or more services associated with UI functionality, one or more backend Representational State Transfer (REST) services, and validation data. The one or more services associated with the data schema may include an ‘add’ feature, a ‘delete’ feature, an ‘update’ feature, and a ‘listing’ feature. The one or more services associated with UI functionality may include a ‘login/logout’ feature, a ‘profiles’ feature, an ‘upload’ feature, a ‘report generation’ feature, a ‘dashboard’ feature, and a ‘notifications’ feature.

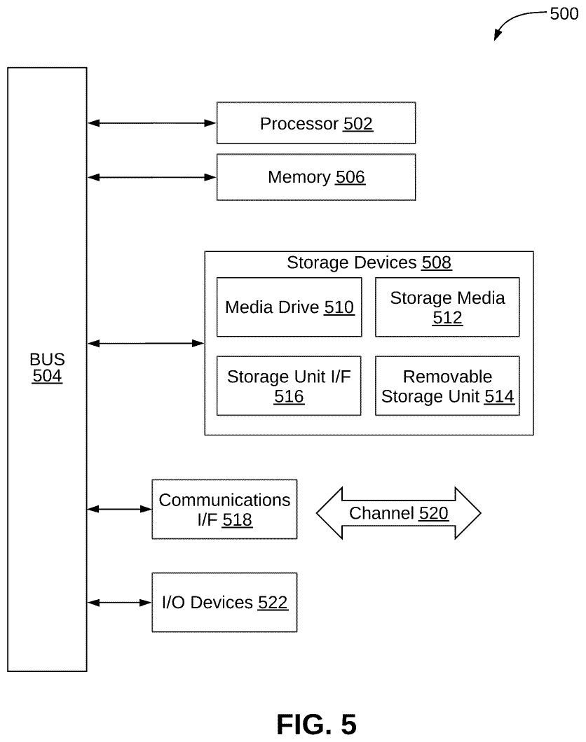

Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication media. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during the execution of instructions to be executed by processor 502. The computing system 500 may likewise include a read-only memory (“ROM”) or other static storage device coupled to bus 504 for storing static information and instructions for the processor 502.

The computing system 500 may also include storage devices 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 512 may include, for example, a hard disk, magnetic tape, flash drive, or other fixed or removable media that is read by and written to by the media drive 510. As these examples illustrate, the storage media 512 may include a computer-readable storage medium having stored therein particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro-USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

One or more techniques for generating code for a User interface (UI) are disclosed in the above sections of the present disclosure. The techniques provide for using GenAI to convert UI prototypes into code, generating database designs, entity classes, REST endpoints, JavaScript/HTML, and remember prompts, thereby save time and effort in the development process. The techniques enable handling Personally Identifiable Information (PII) and applying restriction settings in the generated code. Further, by providing an ability to project UI prototypes in the same viewer and execute commands on captured images, the techniques enhance workflow. As such, the viewer plugin allows to streamline development process and produce high-quality results with minimal configuration overhead on prompt, high security, safety, and robustness with recommendation traceability.

It is intended that the disclosure and examples be considered as exemplary only, with a true scope and spirit of disclosed embodiments being indicated by the following claims.

We claim:

1. A method of generating code for a User interface (UI), the method comprising:
receiving, by a code generating device, from a user, a graphical selection of a target portion of a prototype user interface (UI) rendered via a viewer, using a snipping function, wherein the target portion of the prototype UI comprises a plurality of components;
extracting, by the code generating device, a text representation associated with each of the plurality of components within the target portion of the prototype UI;
mapping, by the code generating device, a text representation associated with each of one or more non-Personally Identifiable Information (PII) components of the plurality of components to one or more text-based prompt-templates, wherein the one or more text-based prompt-templates are prestored in a database; and
generating, by the code generating device, one or more prompts for feeding to a Large Language Model (LLM) for generating a code for the UI, based on the mapping.

2. The method as claimed in claim 1 further comprising:
upon extracting the text representation associated with each of the plurality of components within the target portion of the prototype UI, classifying each of the plurality of components as one of: a PII component and a non-PII component, based on a trained first Machine Learning (ML) model.

3. The method as claimed in claim 1, wherein each of the plurality of components is one of: a text-type component and an image-type component, and wherein extracting the text representation comprises:
converting the image-type component into a corresponding text-type component, using an Optical Character Recognition (OCR) model.

4. The method as claimed in claim 1 further comprising:
determining a context associated with the target portion of the prototype UI, based on the plurality of components, using a trained second ML model.

5. The method as claimed in claim 5 further comprising:
feeding to the LLM model: the one or more prompts, and the context associated with the target portion of the prototype UI; and
receiving from the LLM model, the code for the UI, wherein the LLM is configured to generate the code for the UI based on the one or more prompts, and the context associated with the target portion of the prototype UI.

6. The method as claimed in claim 1, wherein the code comprises:
a data schema, one or more services associated with the data schema, one or more services associated with UI functionality, one or more backend Representational State Transfer (REST) services, and validation data.

7. The method as claimed in claim 6,
wherein the one or more services associated with the data schema comprises: an add feature, a delete feature, an update feature, and a listing feature, and
wherein the one or more services associated with UI functionality comprise: a login/logout feature, a profiles feature, an upload feature, a report generation feature, a dashboard feature, and a notifications feature.

8. A system for generating code for a User interface (UI), the system comprising:
a processor;
a memory communicatively coupled to the processor, the memory storing a plurality of processor-executable instructions, wherein the processor-executable instructions, upon execution by the processor, cause the processor to:
receive, from a user, a graphical selection of a target portion of a prototype user interface (UI) rendered via a viewer, using a snipping function, wherein the target portion of the prototype UI comprises a plurality of components;
extract a text representation associated with each of the plurality of components within the target portion of the prototype UI;
map a text representation associated with each of one or more non-Personally Identifiable Information (PII) components of the plurality of components to one or more text-based prompt-templates, wherein the one or more text-based prompt-templates are prestored in a database; and
generate one or more prompts for feeding to a Large Language Model (LLM) for generating a code for the UI, based on the mapping.

9. The system as claimed in claim 8, wherein the processor-executable instructions further cause the processor to:
upon extracting the text representation associated with each of the plurality of components within the target portion of the prototype UI, classify each of the plurality of components as one of: a PII component and a non-PII component, based on a trained first Machine Learning (ML) model.

10. The system as claimed in claim 8, wherein the processor-executable instructions further cause the processor to:
determine a context associated with the target portion of the prototype UI, based on the plurality of components, using a trained second ML model;
feed to the LLM model: the one or more prompts, and the context associated with the target portion of the prototype UI; and
receiving from the LLM model, the code for the UI, wherein the LLM is configured to generate the code for the UI based on the one or more prompts, and the context associated with the target portion of the prototype UI.
